(19) United States
(12) Patent Application Publication
(10) Pub. No.: US 2006/0033076 A1
(43) Pub. Date: Feb. 16, 2006

(54) Silicate-free cooling liquids based on organic acids and carbamates having improved corrosion properties

(75) Inventors: Markus Hafner, Kastl (DE); Achim Stankowiak, Altoetting (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/200,950

(22) Filed: Aug. 10, 2005

(30) Foreign Application Priority Data
Aug. 12, 2004 (DE) 102004039149.1

(51) Int. Cl. C09K 5/00

(52) U.S. Cl. 252/75

(57) ABSTRACT

The invention relates to coolants or antifreeze concentrates containing:
a) from 0.05 to 5% by weight of one or more carbamates of the formula 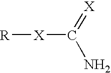 in which X is O or S,

R is C₁- to C₈-alkyl or C₆- to C₁₈-aryl, or the ammonium salts thereof, b) from 0.05 to 4% by weight of a tricarboxylic acid and/or of a triazinetriiminocarboxylic acid, c) from 0.05 to 8% by weight of a mono- and/or dicarboxylic acid having 4 to 16 carbon atoms, in the form of their alkali metal or ammonium salts, d) from 0.01 to 2% by weight of a hydrocarbon-triazole or hydrocarbon-thiazole, e) from 0.01 to 2% by weight of a water-soluble alkali metal salt and/or alkaline earth metal salt and f) from 80 to 99% by weight of alkylene glycols, polyglycols or glycerol.

The present invention relates to novel cooling liquids based on glycols, polyglycols or glycerol which are free of silicates. In addition to other additives, they contain mainly organic acids and a novel, active inhibitor for protecting ferrous and light metals or light metal alloys.

The use of cooling liquids is very problematic, for example in technical systems for cold and heat transport or in modem motor vehicle engines. Owing to the high loads prevailing there on heating surfaces and the high flow rates of the cooling medium, the cooling liquid has to meet very high requirements for protection from all conceivable types of corrosion. In the development of the cooling liquids, the mixed construction customary today also has to be taken into account since metals such as aluminum, iron or steel, cast iron (gray cast iron), copper, brass, lead, tin, zinc and alloys thereof (e.g. soft solder) are used.

Owing to its poor corrosion behavior with respect to aluminum and its alloys, borate-containing heat-transfer liquids are increasingly being dispensed with. In order to achieve the necessary reserve alkalinity of the cooling liquids, organic acid technology (i.e. OAT liquids) was employed. OAT liquids are also as a rule free of silicates. The “hybrid OATs” which contain a little silicate, constitute an exception. In the automotive sector, OAT liquids permit a longer change interval and so-called lifetime filling. With the lack of silicates, however, the remaining light metal protection is all too often insufficient or, in the extreme case, there is no protection at all.

Silicate-free cooling formulations are described, inter alia, in EP-A-0 816 467 and DE 199 30 682 A1. The latter discloses an improvement in the anticorrosion properties of the coolants described, using a triazinetriiminocarboxylic acid and other additives.

DE 102 35 390 A1 describes an antifreeze concentrate for protecting light metal cooling circulations, in particular magnesium and aluminum-containing circulations. Here, the corrosion protection is achieved by a suitable combination of sulfonated and sulfated polyglycols and/or corresponding carbamates and other additives.

It was an object of the present invention to improve the light metal corrosion protection of existing, silicate-free heat-transfer liquids.

Surprisingly, it has now been found that precisely the combination of carbamates with mono-, di- and tricarboxylic acids and also triazinetriiminocarboxylic acids provides outstanding corrosion protection for light and ferrous metals. This is true in particular when there is a high thermal load on these metals, as is the case, for example, in automobile engines.

The invention therefore relates to coolants or antifreeze concentrates containing:

a) from 0.05 to 5% by weight of one or more carbamates of the formula 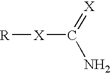
in which

X is O or S,

R is C₁- to C₈-alkyl or C₆- to C₁₈-aryl, or the ammonium salts thereof,

b) from 0.05 to 4% by weight of a tricarboxylic acid and/or of a triazinetriiminocarboxylic acid,

c) from 0.05 to 8% by weight of a mono- and/or dicarboxylic acid having 4 to 16 carbon atoms, in the form of their alkali metal or ammonium salts,

d) from 0.01 to 2% by weight of a hydrocarbon-triazole or hydrocarbon-thiazole,

e) from 0.01 to 2% by weight of a water-soluble alkali metal salt and/or alkaline earth metal salt and

f) from 80 to 99% by weight of alkylene glycols, polyglycols or glycerol.

The invention furthermore relates to aqueous coolant compositions which, in addition to from 5 to 90, preferably from 5 to 80, % by weight of the abovementioned composition according to the invention, contain from 10 to 95, preferably from 20 to 95% by weight of water.

The invention furthermore relates to the use of the abovementioned composition according to the invention as a coolant.

Component a) is preferably present in amounts of from 0.08 to 2% by weight. Examples of suitable carbamates are methyl carbamate, benzyl carbamate, ammonium carbamate and dimethylammoniumdimethyl carbamate. In a particularly preferred embodiment of the invention, methyl carbamate is used.

Component b) comprises tricarboxylic acids and triazinetriiminocarboxylic acids having an aliphatic or aromatic structure in a concentration of, preferably, from 0.1 to 2% by weight. Particularly preferred compounds of this group are 6,6′,6″-(1,3,5-triazine-2,4,6-triyltriimino)trihexanoic acid, 2-hydroxy-1,2,3-propanetricarboxylic acid (citric acid) and benzene-1,3,5-tricarboxylic acid. The acids of component b) may be present as alkali metal salts or ammonium salts. The tricarboxylic acids may also be contained as mixtures having any desired ratios in the antifreeze. The composition according to the invention preferably contains from 0.1 to 4.5, in particular from 0.5 to 4, % by weight of component b).

Branched and/or straight-chain, aliphatic and/or aromatic mono- and dicarboxylic acids are suitable as component c). Examples of such monocarboxylic acids are pentanoic acid, hexanoic acid, heptanoic acid, 2-ethylhexanoic acid, nonanoic acid, isononanoic acid, decanoic acid, undecanoic acid and dodecanoic acid. Preferably, benzoic acid, 4-tert-butylbenzoic acid and 4-methoxybutylbenzoic acid are suitable as aromatic monocarboxylic acids. Examples of dicarboxylic acids are in particular those having 4 to 12 carbon atoms, such as, for example, suberic acid, azelaic acid, sebacic acid, undecanoic acid and dodecanoic acid, but also phthalic acid, isophthalic acid or terephthalic acid. Furthermore, the carboxylic acids described may also contain other functional groups. These include, inter alia, ether, hydroxyl and carboxyl groups. The carboxylic acids are present in the coolant according to the invention in each case in the form of their alkali metal salt or as the corresponding ammonium salt. The mono- and dicarboxylic acids may also be contained as mixtures having any desired ratios in the antifreeze. The composition according to the invention preferably contains from 0.1 to 4.5, in particular from 0.5 to 4, % by weight of component c).

Preferably, a hydrocarbon-triazole, such as tolyltriazole or benzotriazole is suitable as component d), but also suitable imidazoles, thiazoles or pyrimidines. The composition according to the invention preferably contains from 0.05 to 1% by weight of hydrocarbon-triazoles or hydrocarbon-thiazoles.

Component e) serves as a coinhibitor and preferably comprises water-soluble magnesium or potassium salts, which are used, for example, as nitrates. Usually, component e) is used in concentrations of from 0.05 to 1% by weight, particularly preferably from 0.1 to 0.5% by weight.

In addition to monoethylene glycol and 1,2-propylene glycol, suitable polyglycols or glycerols or mixtures thereof are also possible as component D. Monoethylene glycol and 1,2-propylene glycol are preferred.

In a further preferred embodiment, the components a) to f) sum to 100% by weight.

Water (component g)) serves in specific cases as a solubilizer for specific additives, and the compositions according to the invention may optionally contain up to 6% by weight of water.

The cooling liquid according to the invention may optionally also contain up to 4% by weight of compounds selected from alkali metal nitrites, amines, alkali metal phosphates, alkali metal phosphonates, alkali metal borates and alkali metal molybdates as component h).

The cooling liquid according to the invention may optionally also contain up to 1% by weight of suitable hard water stabilizers and/or other suitable additives.

The use of the abovementioned composition in automobile cooling circulations or as a corrosion-inhibiting antifreeze in industrial heating and cooling circulations, in particular in those which contain light metals or alloys thereof, is particularly preferred.

The pH of the antifreeze concentrates in aqueous dilution (1:2) is preferably from 5 to 12, in particular from 7.5 to 9.5.

The cooling liquids according to the invention contain, as a concentrate, predominantly alkylene glycols, but also suitable polyglycols or glycerol. For use in the cooling circulation, the corresponding coolants are as a rule diluted with water. Here, the dilution with water is intended to ensure optimum removal of heat. In a particular embodiment—as a water-soluble corrosion protection concentrate (so-called “chemical”)—disproportionate dilution with water is effected.

Potential applications for the novel fluids are technical systems for heat and cold transport, such as, for example, refrigerated counters, air conditioning systems, thermostating baths, heating systems, heat pumps, solar systems and antifreeze and corrosion protection concentrates for the automotive industry, but also aqueous coolants for metal processing.

### EXAMPLES

The metal ablation values listed in table 1 were obtained by means of a so-called hot corrosion test under heat transmission conditions or a corrosion test according to ASTM D 1384. The conditions in the case of the hot corrosion were: 95° C., 1.5 bar gage pressure, duration of test 47 h, flow rate 210 I/h, load on heating surface 78 W/cm². The standard conditions according to ASTM D 1384 are: 880C, duration of test 336 h, introduction of 6 liters of air/h.

The nitrite-, amine- and phosphate-free coolants (cf. table 1, examples 1 to 4) were all tested in an underconcentration (20% by volume) in demineralized water (hot corrosion test) or in ASTM water (according to ASTM D 1384).

In all examples, the pH of the solutions were adjusted to pH 8.5 as standard (1:2 in demineralized water).

TABLE 1
Metal ablation values of exemplary concentrate formulations, determined by hot corrosion or ASTM D 1384

| Components [% by weight] | Example 1 | Example 2 | Example 3 | Example 4 |
|---|---|---|---|---|
| Monoethylene glycol | Remainder to 100 | Remainder to 100 | Remainder to 100 | Remainder to 100 |
| Tolyltriazole | 0.05 | 0.05 | 0.05 | 0.05 |
| Na nitrate | 0.10 | 0.10 | 0.10 | 0.10 |
| 2-Ethylhexanoic acid Na salt | 0.92 | 0.92 | 0.92 | 0.92 |
| Sebacic acid Na salt | 0.37 | 0.37 | 0.37 | 0.37 |
| Irgacore ® L 190 plus* Na salt | | 0.17 | 0.17 | |
| Methylcarbamate | | | 0.15 | 0.15 |
| Aluminum (AlSi₁₀Mg wa) | Corrosion rate or weight change [mg/plate] after hot corrosion test | | | |
| Weight change after cleaning** of the | −171 | −25 | −31 | −116 |
| AlSi₁₀Mg plates [mg/plate] | | | | |
| | Corrosion rate or weight change [g/m²]; ASTM D 1384 test | | | |
| Copper (pure) | −0.7 | −0.7 | −0.7 | −0.9 |
| Soft solder (WL 30) | −2.6 | −3.4 | −3.0 | −2.8 |
| Brass (MS 63) | −0.7 | −0.8 | −1.1 | −2.6 |
| Steel (CK 22) | −6.9 | ±0 | −0.9 | −0.1 |
| Gray cast iron (GG 25) | −72 | 0 | −0.5 | −61 |
| Cast aluminum (AlSi₆CU₃) | −27 | −33 | −12 | −11 |

*“Irgacore ® L 190 plus” contains 6,6′,6″-(1,3,5-triazine-2,4,6-triyltriimino)trihexanoic acid
**Cleaning method: Pickling with 56% strength nitric acid (10 minutes), water, brush

Example 1 describes a conventionally formulated antifreeze comprising customary ingredients in customary concentration and with average corrosion inhibition. From the comparison of example 2 with example 1, it is clear that the triazinetriiminocarboxylic acid used is an outstanding corrosion inhibitor for ferrous metals. The coolant formulation substantially surpasses the efficiency from example 1 in the ASTM corrosion for the ferrous metals; the metal ablation in the hot corrosion likewise significantly improves. However, the inhibition of cast aluminum in the ASTM test is still not sufficient.

By adding methyl carbamate (example 3), the corrosion behavior of the aluminum alloy in the ASTM corrosion is also decisively improved.

From the comparison of example 3 with example 4, it is clear that the combination of methyl carbamate with carboxylic acid triggers a synergistic effect which substantially surpasses that of the individual components in its action. This effect is most substantial in the comparison of the hot corrosion results of the formulations with the two examples.

Well tailored antifreeze formulations can thus significantly improve the corrosion rate of a customary formulation in the hot test and in the ASTM corrosion.

1. A coolant or antifreeze concentrate comprising:
a) from 0.05 to 5% by weight of one or more carbamates of the formula 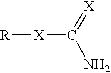
in which
X is O or S,
R is C₁- to C₈-alkyl or C₆- to C₁₈-aryl, or the ammonium salts thereof,
b) from 0.05 to 4% by weight of a tricarboxylic acid or of a triazinetriiminocarboxylic acid, or a mixture thereof,
c) from 0.05 to 8% by weight of a mono- or a dicarboxylic acid having 4 to 16 carbon atoms, or a mixture thereof, in the form of their alkali metal or ammonium salts,
d) from 0.01 to 2% by weight of a hydrocarbon-triazole or hydrocarbon-thiazole, or a mixture thereof,
e) from 0.01 to 2% by weight of a water-soluble alkali metal salt or alkaline earth metal salt, or a mixture thereof, and
f) from 80 to 99% by weight of a compound selected from the group consisting of an alkylene glycol, a polyglycol, a glycerol, and mixtures thereof.

2. The composition as claimed in claim 1, which further comprises up to 4% by weight of component h) selected from the group consisting of alkali metal nitrites, alkali metal amines, alkali metal phosphates, alkali metal phosphonates, alkali metal borates, alkali metal molybdates, and mixtures thereof.

3. The composition of claim 1, which further comprises up to 6% by weight of water.

4. The composition of claim 2, which further comprises up to 6% by weight of water.

5. A mixture comprising from 5 to 90% by weight of the composition as claimed in claim 1 and from 10 to 95% by weight of water.
